(19) United States
(12) Patent Application Publication
(10) Pub. No.: US 2013/0125093 A1
(43) Pub. Date: May 16, 2013

(54) GENERATING OBJECT-ORIENTED PROGRAMMING LANGUAGE CODE FROM A MULTI-DOMAIN DYNAMIC SIMULATION MODEL

(71) Applicants: Geetha Mandava, Olney, MD (US); Yan Liu, Westford, MA (US)

(72) Inventors: Geetha Mandava, Olney, MD (US); Yan Liu, Westford, MA (US)

(73) Assignee: GENERAL ELECTRIC COMPANY, Schenectady, NY (US)

(21) Appl. No.: 13/294,687

(22) Filed: Nov. 11, 2011

(51) Int. Cl. G06F 9/44

(52) U.S. Cl. 717/108

(57) ABSTRACT

A method for generating an object oriented programming language source code from a simulation model includes receiving the simulation model, generating header files from the simulation model, in a general programming language, generating bridge code that aids in generating object-oriented programming language templates that include template maps, generating object-oriented programming language components from the template maps, aggregating the object-oriented programming language components; and generating object-oriented programming language source code and wrappers from aggregating the object-oriented programming language components.

### BACKGROUND OF THE INVENTION

The subject matter disclosed herein relates to object-oriented programming languages, and multi-domain dynamic simulation models, and more particularly to generating an object oriented programming language source code from a multi-domain dynamic simulation model.

Design-based simulation models such as Simulink are useful for prototyping, implementing and testing models and algorithms. Object-oriented programming languages such as Java are useful for coding the algorithms prototyped in the simulation model. The designer/programmer typically codes the design in the simulation model, and then codes the successful design in the object-oriented programming language. Currently, the designer/programmer must recode a successful design into the object-oriented programming language.

### BRIEF DESCRIPTION OF THE INVENTION

According to one aspect of the invention, a method for generating an object oriented programming language source code from a simulation model is described. The method includes receiving the simulation model, generating header files from the simulation model, in a general programming language, generating bridge code that aids in generating object-oriented programming language templates that include template maps, generating object-oriented programming language components from the template maps, aggregating the object-oriented programming language components; and generating object-oriented programming language source code and wrappers from aggregating the object-oriented programming language components.

According to another aspect of the invention, a computer program product for generating an object oriented programming language source code from a simulation model. The computer program product includes a non-transitory computer readable medium storing instructions for causing a computer to implement a method. The method includes receiving the simulation model, generating header files from the simulation model, in a general programming language, generating bridge code that aids in generating object-oriented programming language templates that include template maps, generating object-oriented programming language components from the template maps, aggregating the object-oriented programming language components; and generating object-oriented programming language source code and wrappers from aggregating the object-oriented programming language components.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a flowchart of a method for generating an object oriented language source code from a multi-domain dynamic simulation model or other model-based designs in accordance with exemplary embodiments;

FIG. 2 illustrates a flowchart of a method for generating Java code from a Simulink design in accordance with exemplary embodiments; and

FIG. 3 illustrates an exemplary embodiment of a system for generating object-oriented code (e.g., Java) from a multi-domain dynamic simulation model or other model-based design (e.g., Simulink).

The detailed description explains embodiments of the invention, together with advantages and features, by way of example with reference to the drawings.

### DETAILED DESCRIPTION OF THE INVENTION

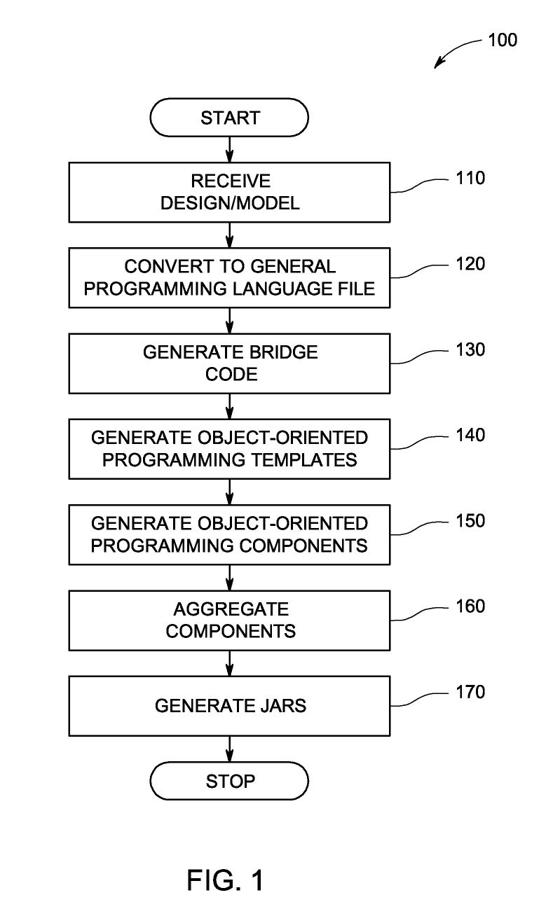

FIG. 1 illustrates a flowchart of a method 100 for generating an object oriented language source code from a multi-domain dynamic simulation model or other model-based designs in accordance with exemplary embodiments. FIG. 1 illustrates a generalized method. For illustrative purposes, an example of generating Java code from Simulink is described herein. As such, a designer/programmer designs their models in Simulink and deploys it as a Java web service. The Java classes can be integrated into Java programs and deployed to Web servers. The systems and methods described herein first create the C/C++ code from Simulink and then generate Java wrappers around the code so that the code behaves just like any other Java class. These java classes are portable and run on all platforms supported by Simulink. It will be appreciated that the systems and methods described herein can be applied to any model-based designs and object oriented language. It will further be appreciated that the method 100 can be implemented in any suitable computing system. At block 110, the model or design is received in the computing system. At block 120, the computing system generates header files in a general programming language such as C-programming language or a multi-paradigm general programming language such as C++. At block 130, the computing system generates bridge code that aids in generating the object-oriented programming language templates at block 140. At block 150, the computing system generates object-oriented programming language components, which are aggregated at block 160 to generate source code and wrappers that can be subsequently implemented to directly access the design model components through the object-oriented programming language. In addition, any data types from the object oriented programming language can be directly passed to the design model. As such, at block 170, the computing system generates jars that aggregate components into single usable files (i.e., jars), such that the Java applications (i.e., Simulink application) can be distributed in the form of Java class files and associated metadata and resources (text, images, etc.).

As described herein, the systems and methods described herein can be implemented to automatically generate Java code (e.g., Java wrapper classes) from Simulink so that there is no need to rewrite the Simulink code in Java. The systems and methods described herein can therefore reduce migration time from design to production. Java is an object-oriented programming language that derives much of the syntax from the C and C++ programming language but has a simpler object model and fewer low-level facilities. Java applications are typically compiled to bytecode (class file) that can run on any Java Virtual Machine (JVM) regardless of computer architecture. Java is a general-purpose, concurrent, class-based, object-oriented language that is specifically designed to have as few implementation dependencies as possible, thereby allowing application developers “write once, run anywhere”. Java wrapper classes are used to represent primitive values, that is, data types that are basic building blocks on the language. Simulink is a commercial tool for modeling, simulating and analyzing multi-domain dynamic systems. It is a high-level, matrix-optimized language with built-in math, graphics, and data analysis functions. Its primary interface is a graphical block diagramming tool and a customizable set of block libraries.

In exemplary embodiments, a Simulink-to-Java implementation enables a designer/programmer to develop applications using Simulink, and then incorporate the application in Java programs. Simulink is used to rapidly prototype, implement, and test design algorithms. Once an application is complete, the designer/programmer uses the Simulink-to-Java implementation to automatically package Simulink code as Java classes. The Java classes can be integrated in a Java application and referenced in the same way as standard Java classes.

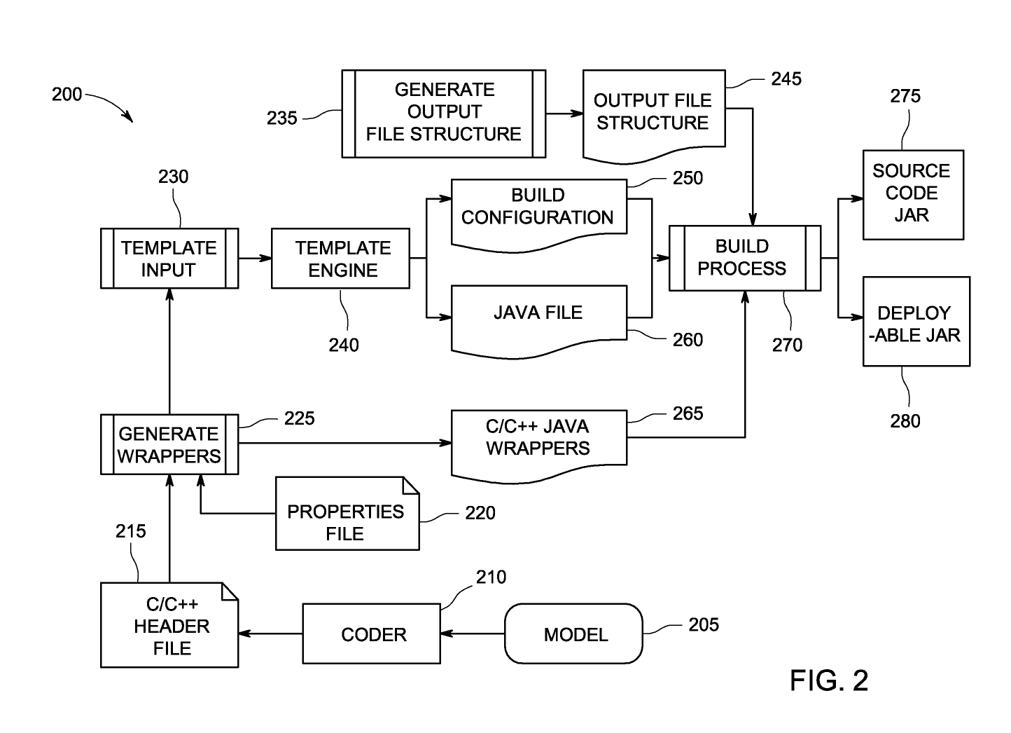

FIG. 2 illustrates a flowchart of a method 200 for generating Java code from a Simulink design in accordance with exemplary embodiments. At block 205 the computing system receives a Simulink model designed by a user, and generates C/C++ code via a Simulink coder at block 210 to generate C/C++ code and to extract C/C++ headers at block 215. A user can provide a properties file at block 220. Properties file can include but are not limited to a package name, a version of source code and a project name. If the user does not provide a properties file, the method 200 can use default files that are included with the C/C++ header files. At block 225, the computing system generates Java wrapper classes from the C/C++ header files and the properties files. As described herein, Java includes multiple primitive types that represent basic data building blocks. Java wrapper classes are used to represent primitive types into respective wrapper objects. In exemplary embodiments, Jnaerator is implemented to generate the Java wrapper classes. Jnaerator parses C/C++ headers and generates the corresponding Java Interfaces, which lets Java programmers access native libraries transparently. Jnaerator automatically generates Java native access (i.e., bridge code) that is used to call C/C++ libraries from Java code. At block 230, the computing system generates template inputs. At block 240, the template inputs from block 230 are received to generate Java source code. In exemplary embodiments, “FreeMarker” is used to generate the Java Source code. FreeMarker is a generic tool to generate text output (e.g., anything from HTML to autogenerated source code) based on templates. Freemarker is a Java package, a class library for Java programmers. At block 235, the user can provide output file structures to define how to structure the build process for the Java components. As such, at block 245 the computing system generates an output file structure at block 245. At block 250, the template engine generates a build configuration component. At block 260, the template engine generates a Java file component. At block 265, C/C++ Java wrappers are generated from block 225. The Java components at blocks 245, 250, 260, 265 are combined at block 270 (e.g., an automatic build script). At block 275, the computing system generates a source code jar and at block 280, the computing system generates a deployable jar. The jar files aggregate the generated components at blocks 245, 250, 260, 265 into single usable files (i.e., jars), such that the Java applications (i.e., Simulink application) can be distributed in the form of Java class files and associated metadata and resources (text, images, etc.). The source code jar stores all of the source code related to the Simulink application, and the deployable jar includes the executable application. After instantiating the Java classes from the Simulink based components, the designer/programmer can access Simulink functions as native Java methods. Native Java data types passed to Simulink functions are automatically converted to Simulink data types.

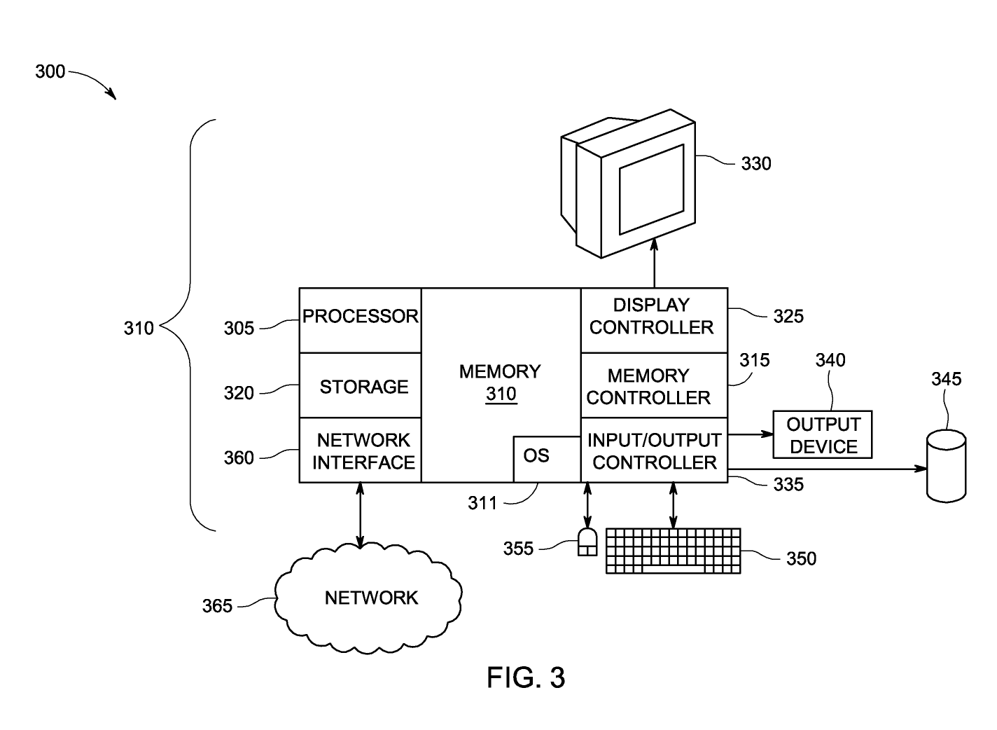

The computing system described herein can be any suitable computing system as now described. FIG. 3 illustrates an exemplary embodiment of a system 300 for generating object-oriented code (e.g., Java) from a multi-domain dynamic simulation model or other model-based design (e.g., Simulink). The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 300 therefore includes general-purpose computer 301.

In exemplary embodiments, in terms of hardware architecture, as shown in FIG. 3, the computer 301 includes a processor 305, memory 310 coupled to a memory controller 315, and one or more input and/or output (I/O) devices 340, 345 (or peripherals) that are communicatively coupled via a local input/output controller 335. The input/output controller 335 can be, but is not limited to, one or more buses or other wired or wireless connections, as is known in the art. The input/output controller 335 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 305 is a hardware device for executing software, particularly that stored in memory 310. The processor 305 can be any custom made or commercially available processor, a central processing unit (CPU), an auxiliary processor among several processors associated with the computer 301, a semiconductor based microprocessor (in the form of a microchip or chip set), a macroprocessor, or generally any device for executing software instructions.

The memory 310 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 310 may incorporate electronic, magnetic, optical, and/or other types of storage media. Note that the memory 310 can have a distributed architecture, where various components are situated remote from one another, but can be accessed by the processor 305.

The software in memory 310 may include one or more separate programs, each of which comprises an ordered listing of executable instructions for implementing logical functions. In the example of FIG. 3, the software in the memory 310 includes the code generator methods described herein in accordance with exemplary embodiments and a suitable operating system (OS) 311. The OS 311 essentially controls the execution of other computer programs, such the code generator systems and methods as described herein, and provides scheduling, input-output control, file and data management, memory management, and communication control and related services.

The code generator methods described herein may be in the form of a source program, executable program (object code), script, or any other entity comprising a set of instructions to be performed. When a source program, then the program needs to be translated via a compiler, assembler, interpreter, or the like, which may or may not be included within the memory 310, so as to operate properly in connection with the OS 311. Furthermore, the code generator methods can be written as an object oriented programming language, which has classes of data and methods, or a procedure programming language, which has routines, subroutines, and/or functions.

In exemplary embodiments, a conventional keyboard 350 and mouse 355 can be coupled to the input/output controller 335. Other output devices such as the I/O devices 340, 345 may include input devices, for example but not limited to a printer, a scanner, microphone, and the like. Finally, the I/O devices 340, 345 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 300 can further include a display controller 325 coupled to a display 330. In exemplary embodiments, the system 300 can further include a network interface 360 for coupling to a network 365. The network 365 can be an IP-based network for communication between the computer 301 and any external server, client and the like via a broadband connection. The network 365 transmits and receives data between the computer 301 and external systems. In exemplary embodiments, network 365 can be a managed IP network administered by a service provider. The network 365 may be implemented in a wireless fashion, e.g., using wireless protocols and technologies, such as WiFi, WiMax, etc. The network 365 can also be a packet-switched network such as a local area network, wide area network, metropolitan area network, Internet network, or other similar type of network environment. The network 365 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 301 is a PC, workstation, intelligent device or the like, the software in the memory 310 may further include a basic input output system (BIOS) (omitted for simplicity). The BIOS is a set of essential software routines that initialize and test hardware at startup, start the OS 311, and support the transfer of data among the hardware devices. The BIOS is stored in ROM so that the BIOS can be executed when the computer 301 is activated.

When the computer 301 is in operation, the processor 305 is configured to execute software stored within the memory 310, to communicate data to and from the memory 310, and to generally control operations of the computer 301 pursuant to the software. The code generator methods described herein and the OS 311, in whole or in part, but typically the latter, are read by the processor 305, perhaps buffered within the processor 305, and then executed.

When the systems and methods described herein are implemented in software, as is shown in FIG. 3, the methods can be stored on any computer readable medium, such as storage 320, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the code generator methods are implemented in hardware, the code generator methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Technical effects include automatically generating an object-oriented programming language code such as Java from a multi-domain dynamic simulation model or other design-based models such as Simulink so that there is no need to rewrite the design-based model code in the object-oriented programming language code. Migration time from design to production can be greatly reduced. In addition, re-implementation of the object-oriented programming language code is eliminated, reducing time from design to production.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method for generating an object oriented programming language source code from a simulation model, the method comprising:
receiving, in a processor, the simulation model;
generating, in the processor, header files from the simulation model, in a general programming language;
generating, in the processor, bridge code that aids in generating object-oriented programming language templates that include template maps;
generating, in the processor, object-oriented programming language components from the template maps;
aggregating, in the processor, the object-oriented programming language components; and
generating, in the processor, object-oriented programming language source code and wrappers from aggregating the object-oriented programming language components.

2. The method as claimed in claim 1 wherein the general programming language is at least one of C programming language and C++ programming language.

3. The method as claimed in claim 1 further comprising receiving, in the processor, a properties file.

4. The method as claimed in claim 1 wherein the object-oriented programming language components are primitive wrapper classes.

5. The method as claimed in claim 4 wherein the primitive wrapper classes represent primitive types in respective wrapper objects.

6. The method as claimed in claim 1 wherein the object-oriented programming language components are generated from the object-oriented programming language templates.

7. The method as claimed in claim 1 further comprising generating, in the processor, an output file structure for the object-oriented programming language components.

8. The method as claimed in claim 1 further comprising generating, in the processor, a source code jar.

9. The method as claimed in claim 1 further comprising generating, in the processor, a deployable jar.

10. The method as claimed in claim 1 wherein the simulation model is distributed in a form of the object-oriented programming language class files, and wherein functions associated with the simulation model are accessed as native object-oriented programming language functions.

11. A computer program product for generating an object oriented programming language source code from a simulation model, the computer program product including a non-transitory computer readable medium storing instructions for causing a computer to implement a method, the method comprising:
receiving the simulation model;
generating header files from the simulation model, in a general programming language;
generating bridge code that aids in generating object-oriented programming language templates that include template maps;
generating object-oriented programming language components from the template maps;
aggregating the object-oriented programming language components; and
generating object-oriented programming language source code and wrappers from aggregating the object-oriented programming language components.

12. The computer program product as claimed in claim 11 wherein the general programming language is at least one of C programming language and C++ programming language.

13. The computer program product as claimed in claim 11 wherein the method further comprises receiving a properties file.

14. The computer program product as claimed in claim 11 wherein the object-oriented programming language components are primitive wrapper classes.

15. The computer program product as claimed in claim 14 wherein the primitive wrapper classes represent primitive types in respective wrapper objects.

16. The computer program product as claimed in claim 11 wherein the object-oriented programming language components are generated from the object-oriented programming language templates.

17. The computer program product as claimed in claim 11 wherein the method further comprises generating an output file structure for the object-oriented programming language components.

18. The computer program product as claimed in claim 11 wherein the method further comprises generating a source code jar.

19. The computer program product as claimed in claim 11 wherein the method further comprises generating a deployable jar.

20. The computer program product as claimed in claim 11 wherein the simulation model is distributed in a form of the object-oriented programming language class files, and wherein functions associated with the simulation model are accessed as native object-oriented programming language functions.
